(19) United States
(12) Patent Application Publication
(10) Pub. No.: US 2005/0188182 A1
(43) Pub. Date: Aug. 25, 2005

(54) Microprocessor having a set of byte intermingling instructions

(75) Inventors: David Hoyle, Glendale, AZ (US); Vishal Markandey, Dallas, TX (US); Lewis Nardini, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/114,549

(22) Filed: Apr. 26, 2005

Related U.S. Application Data
(62) Division of application No. 09/702,405, filed on Oct. 31, 2000.
(60) Provisional application No. 60/183,527, filed on Feb. 18, 2000.
(60) Provisional application No. 60/173,761, filed on Dec. 30, 1999.

(51) Int. Cl. G06F 15/00

(52) U.S. Cl. 712/224

(57) ABSTRACT

A data processing system is provided with a digital signal processor that has a set of instructions for intermingling byte fields selected from a selected pair of source operands and storing the ordered result in a selected destination register. A first 32-bit operand is treated as four 8-bit fields while a second 32-bit operand is treated as four 8-bit fields. Intermingling circuitry is operable to form an ordered result in accordance with each one of the set of byte intermingling instructions. An instruction is provided that performs a shift right and byte merge operation. Another instruction is provided that performs a shift left and byte merge operation. Another instruction is provided that perform a byte swap operation. A set of instructions are provided that perform various byte packing and unpacking operations.

This application is a divisional of application Ser. No. 09/702,405, filed Oct. 31, 2000, which claims priority under 35 USC §119(e)(1) of Provisional Application No. 60/183,527, filed Feb. 18, 2000 and of Provisional Application No. 60/173,761, filed Dec. 30, 1999; and which is related to copending application Ser. No. 09/703,096 filed Oct. 31, 2000, which claims priority of Provisional Application No. 60/183,527; and which is related to copending application Ser. No. 09/687,540 filed Oct. 13, 2000, which claims priority of Provisional Application No. 60/173,761.

### NOTICE

(C) Copyright 2000 Texas Instruments Incorporated. A portion of the disclosure of this patent document contains material that is subject to copyright protection. The copyright owner has no objection to the facsimile reproduction by anyone of the patent disclosure, as it appears in the Patent and Trademark Office patent file or records, but otherwise reserves all copyright rights whatsoever.

### TECHNICAL FIELD OF THE INVENTION

This invention relates to data processing devices, electronic processing and control systems and methods of their manufacture and operation, and particularly relates to microprocessors optimized for digital signal processing.

### BACKGROUND OF THE INVENTION

Generally, a microprocessor is a circuit that combines the instruction-handling, arithmetic, and logical operations of a computer on a single semiconductor integrated circuit. Microprocessors can be grouped into two general classes, namely general-purpose microprocessors and special-purpose microprocessors. General-purpose microprocessors are designed to be programmable by the user to perform any of a wide range of tasks, and are therefore often used as the central processing unit (CPU) in equipment such as personal computers. Special-purpose microprocessors, in contrast, are designed to provide performance improvement for specific predetermined arithmetic and logical functions for which the user intends to use the microprocessor. By knowing the primary function of the microprocessor, the designer can structure the microprocessor architecture in such a manner that the performance of the specific function by the special-purpose microprocessor greatly exceeds the performance of the same function by a general-purpose microprocessor regardless of the program implemented by the user.

One such function that can be performed by a special-purpose microprocessor at a greatly improved rate is digital signal processing. Digital signal processing generally involves the representation, transmission, and manipulation of signals, using numerical techniques and a type of special-purpose microprocessor known as a digital signal processor (DSP). Digital signal processing typically requires the manipulation of large volumes of data, and a digital signal processor is optimized to efficiently perform the intensive computation and memory access operations associated with this data manipulation. For example, computations for performing Fast Fourier Transforms (FFTs) and for implementing digital filters consist to a large degree of repetitive operations such as multiply-and-add and multiple-bit-shift. DSPs can be specifically adapted for these repetitive functions, and provide a substantial performance improvement over general-purpose microprocessors in, for example, real-time applications such as image and speech processing.

DSPs are central to the operation of many of today's electronic products, such as high-speed modems, high-density disk drives, digital cellular phones, complex automotive systems, and video-conferencing equipment. DSPs will enable a wide variety of other digital systems in the future, such as video-phones, network processing, natural speech interfaces, and ultra-high speed modems. The demands placed upon DSPs in these and other applications continue to grow as consumers seek increased performance from their digital products, and as the convergence of the communications, computer and consumer industries creates completely new digital products.

Microprocessor designers have increasingly endeavored to exploit parallelism to improve performance. One parallel architecture that has found application in some modern microprocessors utilizes multiple instruction fetch packets and multiple instruction execution packets with multiple functional units.

Digital systems designed on a single integrated circuit are referred to as an application specific integrated circuit (ASIC). MegaModules are being used in the design of ASICs to create complex digital systems a single chip. (MegaModule is a trademark of Texas Instruments Incorporated.) Types of MegaModules include SRAMs, FIFOs, register files, RAMs, ROMs, universal asynchronous receiver-transmitters (UARTs), programmable logic arrays and other such logic circuits. MegaModules are usually defined as integrated circuit modules of at least 500 gates in complexity and having a complex ASIC macro function. These MegaModules are predesigned and stored in an ASIC design library. The MegaModules can then be selected by a designer and placed within a certain area on a new IC chip.

Designers have succeeded in increasing the performance of DSPs, and microprocessors in general, by increasing clock speeds, by removing data processing bottlenecks in circuit architecture, by incorporating multiple execution units on a single processor circuit, and by developing optimizing compilers that schedule operations to be executed by the processor in an efficient manner. The increasing demands of technology and the marketplace make desirable even further structural and process improvements in processing devices, application systems and methods of operation and manufacture.

### SUMMARY OF THE INVENTION

An illustrative embodiment of the present invention seeks to provide a microprocessor, and a method for operating a microprocessor that improves digital signal processing performance. Aspects of the invention are specified in the claims.

In an embodiment of the present invention, a digital signal processor is provided with byte intermingling circuitry for selecting fields from a selected pair of source operands and intermingling the selected fields in an order in accordance with each one of a set of byte intermingling instructions.

In an embodiment of the invention, a 32-bit operand is treated as four 8-bit byte fields and the four fields are selected separately. In another embodiment, an operand size different from 32-bits may be operated on, and the field sizes may be different than eight bits.

In an embodiment of the invention, one instruction is provided that performs a shift right and byte merge operation. Another instruction is provided that performs a shift left and byte merge operation. Another instruction is provided that perform a byte swap operation. A set of instructions are provided that perform various byte packing and unpacking operations.

### BRIEF DESCRIPTION OF THE DRAWINGS

Other features and advantages of the present invention will become apparent by reference to the following detailed description when considered in conjunction with the accompanying drawings, in which:

FIG. 1 is a block diagram of a digital signal processor (DSP), showing components thereof pertinent to an embodiment of the present invention;

FIG. 2 is a block diagram of the functional units, data paths and register files of FIG. 1;

FIGS. 3A-3J show an opcode map for the DSP of FIG. 1;

FIG. 4 is a timing diagram illustrating instruction execution pipeline phase of the processor of FIG. 1;

FIG. 5A and 5B illustrate an instruction syntaxes for multi-field intermingling instructions;

FIG. 6A is a flow chart illustrating operation of a Shift Left and Merge Byte (SHLMB) instruction;

FIG. 6B illustrates a destination operand for a Shift Right and Merge Byte (SHRMB) instruction;

FIG. 6C illustrates a destination operand for a Swap half word (SWAP2) instruction;

FIG. 6D illustrates a destination operand for a Swap Bytes is each half word (SWAP4) instruction;

FIG. 6E illustrates a destination operand for a Pack two low half words (PACK2) instruction;

FIG. 6F illustrates a destination operand for a Pack two High half words (PACKH2) instruction;

FIG. 6G illustrates a destination operand for a Pack High bytes of four half words (PACKH4) instruction;

FIG. 6H illustrates a destination operand for a Pack High half word and Low half word (PACKHL2) instruction;

FIG. 6I illustrates a destination operand for a Pack Low bytes of Four half words (PACKL4) instruction;

FIG. 6J illustrates a destination operand for a Pack Low half word and High half words (PACKLH2) instruction;

FIG. 6K illustrates a destination operand for an Unpack High Unsigned 8-bit to unsigned 16-bit (UNPKHU4) instruction;

FIG. 6L illustrates a destination operand for an Unpack Low Unsigned 8-bit to unsigned 16-bit (UNPKLU4) instruction;

FIG. 7A is a block diagram illustrating a multi-field intermingling circuit for performing a set of byte intermingling instructions within an .L functional unit of the processor of FIG. 1;

FIG. 7B is a more detailed block diagram of the intermingling circuit of FIG. 7A;

FIG. 7C is an alternate embodiment of an intermingling circuit;

FIG. 8 is a block diagram of an alternative embodiment of the processor of FIG. 1; and

FIG. 9 illustrates an exemplary implementation of a digital system that includes an embodiment of the present invention in a mobile telecommunications device.

### DETAILED DESCRIPTION OF EMBODIMENTS OF THE INVENTION

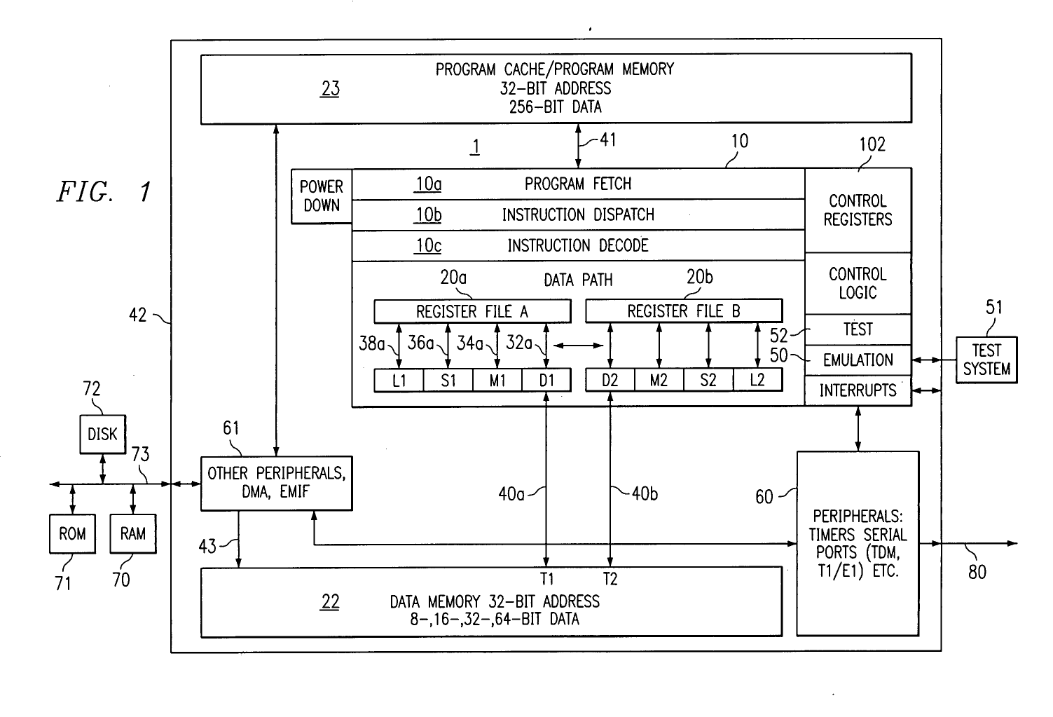

FIG. 1 is a block diagram of a microprocessor 1 which has an embodiment of the present invention. Microprocessor 1 is a VLIW digital signal processor (“DSP”). In the interest of clarity, FIG. 1 only shows those portions of microprocessor 1 that are relevant to an understanding of an embodiment of the present invention. Details of general construction for DSPs are well known, and may be found readily elsewhere. For example, U.S. Pat. No. 5,072,418 issued to Frederick Boutaud, et al, describes a DSP in detail and is incorporated herein by reference. U.S. Pat. No. 5,329,471 issued to Gary Swoboda, et al, describes in detail how to test and emulate a DSP and is incorporated herein by reference. Details of portions of microprocessor 1 relevant to an embodiment of the present invention are explained in sufficient detail hereinbelow, so as to enable one of ordinary skill in the microprocessor art to make and use the invention.

In microprocessor 1 there are shown a central processing unit (CPU) 10, data memory 22, program memory 23, peripherals 60, and an external memory interface (EMIF) with a direct memory access (DMA) 61, coupled to data memory 22 via lines 43. CPU 10 further has an instruction fetch/decode unit 10a-c, a plurality of execution units, including an arithmetic and load/store unit D1, a multiplier M1, an ALU/shifter unit S1, an arithmetic logic unit (“ALU”) L1, a shared multiport register file 20a from which data are read and to which data are written. Instructions are fetched by fetch unit 10a from instruction memory 23 over a set of busses 41. Decoded instructions are provided from the instruction fetch/decode unit 10a-c to the functional units D1, M1, S1, and L1 over various sets of control lines which are not shown. Data are provided to/from the register file 20a from/to to load/store units D1 over a first set of busses 32a, to multiplier M1 over a second set of busses 34a, to ALU/shifter unit S1 over a third set of busses 36a and to ALU L1 over a fourth set of busses 38a. Data are provided to/from the memory 22 from/to the load/store units D1 via a fifth set of busses 40a. Note that the entire data path described above is duplicated with register file 20b and execution units D2, M2, S2, and L2. In this embodiment of the present invention, two unrelated aligned double word (64 bits) load/store transfers can be made in parallel between CPU 10 and data memory 22 on each clock cycle using bus set 40a and bus set 40b.

A single non-aligned double word load/store transfer is performed by scheduling a first .D unit resource and two load/store ports on memory 22. Advantageously, an extraction circuit is connected to the memory subsystem to provide a non-aligned data item extracted from two aligned data items requested by the .D unit. Advantageously, a second .D unit can perform 32-bit logical or arithmetic instructions in addition to the .S and .L units while the address port of the second .D unit is being used to transmit one of two contiguous addresses provided by the first .D unit. Furthermore, a non-aligned access near the end of a circular buffer region in the target memory provides a non-aligned data item that wraps around to the other end of the circular buffer.

Emulation circuitry 50 provides access to the internal operation of integrated circuit 1 that can be controlled by an external test/development system (XDS) 51. External test system 51 is representative of a variety of known test systems for debugging and emulating integrated circuits. One such system is described in U.S. Pat. No. 5,535,331 which is incorporated herein by reference. Test circuitry 52 contains control registers and parallel signature analysis circuitry for testing integrated circuit 1.

Note that the memory 22 and memory 23 are shown in FIG. 1 to be a part of a microprocessor 1 integrated circuit, the extent of which is represented by the box 42. The memories 22-23 could just as well be external to the microprocessor 1 integrated circuit 42, or part of it could reside on the integrated circuit 42 and part of it be external to the integrated circuit 42. These are matters of design choice. Also, the particular selection and number of execution units are a matter of design choice, and are not critical to the invention.

When microprocessor 1 is incorporated in a data processing system, additional memory or peripherals may be connected to microprocessor 1, as illustrated in FIG. 1. For example, Random Access Memory (RAM) 70, a Read Only Memory (ROM) 71 and a Disk 72 are shown connected via an external bus 73. Bus 73 is connected to the External Memory Interface (EMIF) which is part of functional block 61 within microprocessor 1. A Direct Memory Access (DMA) controller is also included within block 61. The DMA controller is generally used to move data between memory and peripherals within microprocessor 1 and memory and peripherals which are external to microprocessor 1.

In the present embodiment, CPU core 10 is encapsulated as a MegaModule, however, other embodiments of the present invention may be in custom designed CPU's or mass market microprocessors, for example.

A detailed description of various architectural features of the microprocessor of FIG. 1 is provided in coassigned application Ser. No. 09/012,813, now U.S. Pat. No. 6,182,203, and is incorporated herein by reference. A description of enhanced architectural features and an extended instruction set not described herein for CPU 10 is provided in coassigned U.S. patent application Ser. No. 09/703,096, Microprocessor with Improved Instruction Set Architecture, and is incorporated herein by reference.

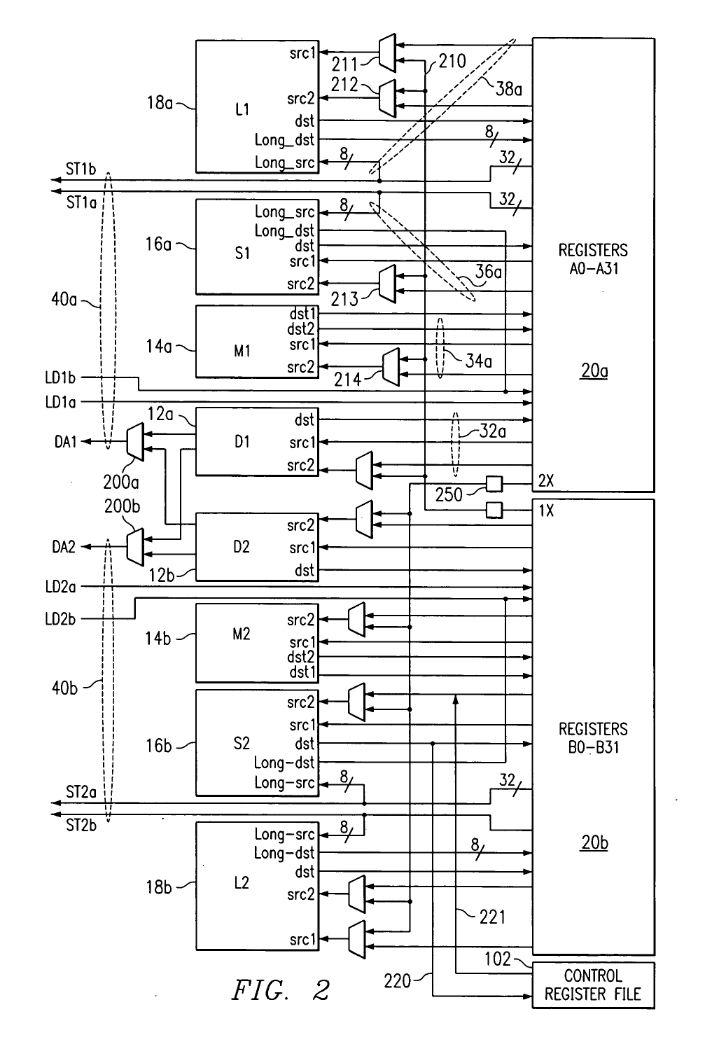

FIG. 2 is a block diagram of the execution units and register files of the microprocessor of FIG. 1 and shows a more detailed view of the buses connecting the various functional blocks. In this figure, all data busses are 32 bits wide, unless otherwise noted. There are two general-purpose register files (A and B) in the processor's data paths. Each of these files contains 32 32-bit registers (A0-A31 for file A and B0-B31 for file B). The general-purpose registers can be used for data, data address pointers, or condition registers. Any number of reads of a given register can be performed in a given cycle.

The general-purpose register files support data ranging in size from packed 8-bit data through 64-bit fixed-point data. Values larger than 32 bits, such as 40-bit long and 64-bit double word quantities, are stored in register pairs, with the 32 LSBs of data placed in an even-numbered register and the remaining 8 or 32 MSBs in the next upper register (which is always an odd-numbered register). Packed data types store either four 8-bit values or two 16-bit values in a single 32-bit register.

There are 32 valid register pairs for 40-bit and 64-bit data, as shown in Table 1. In assembly language syntax, a colon between the register names denotes the register pairs and the odd numbered register is encoded in the instruction opcode.

TABLE 1
40-Bit/64-Bit Register Pairs
Register Files

| A | B |
|---|---|
| A1:A0 | B1:B0 |
| A3:A2 | B3:B2 |
| A5:A4 | B5:B4 |
| A7:A6 | 67:B6 |
| A9:A8 | B9:B8 |
| A11:A10 | B11:B10 |
| A13:A12 | B13:B12 |
| A15:A14 | B15:B14 |
| A17:A16 | B17:B16 |
| A19:A18 | B19:B18 |
| A21:A20 | B21:B20 |
| A23:A22 | B23:B22 |
| A25:A24 | B25:B24 |
| A27:A26 | B27:B26 |
| A29:A28 | B29:B28 |
| A31:A30 | B31:B30 |

For 40-bit data, operations requiring a long input ignore the 24 MSBs of the odd register. Operations producing a long result zero-fill the 24 MSBs of the odd register. The even register is encoded in the opcode.

The eight functional units in processor 10's data paths are be divided into two groups of four; each functional unit in one data path is almost identical to the corresponding unit in the other data path. The functional units are described in Table 2.

Besides being able to perform 32-bit data manipulations, processor 10 also contains many 8-bit and 16-bit data instructions in the instruction set. For example, the MPYU4 instruction performs four 8×8 unsigned multiplies with a single instruction on a .M unit. The ADD4 instruction performs four 8-bit additions with a single instruction on a .L unit.

TABLE 2
Functional Units and Operations Performed

| Functional Unit | Fixed-Point Operations |
|---|---|
| .L unit (.L1, .L2) | 32/40-bit arithmetic and compare |
| | operations |
| | 32-bit logical operations |
| | Leftmost 1 or 0 counting for 32 bits |
| | Normalization count for 32 and 40 bits |
| | Byte shifts |
| | Data packing/unpacking |
| | 5-bit constant generation |
| | Paired 16-bit arithmetic operations |
| | Quad 8-bit arithmetic operations |
| | Paired 16-bit min/max operations |
| | Quad 8-bit min/max operations |
| .S unit (.S1, .S2) | 32-bit arithmetic operations |
| | 32/40-bit shifts and 32-bit bit-field |
| | operations |
| | 32-bit logical operations |
| | Branches |
| | Constant generation |
| | Register transfers to/from control |
| | register file (.S2 only) |
| | Byte shifts |
| | Data packing/unpacking |
| | Paired 16-bit compare operations |
| | Quad 8-bit compare operations |
| | Paired 16-bit shift operations |
| | Paired 16-bit saturated arithmetic |
| | operations |
| | Quad 8-bit saturated arithmetic |
| | operations |
| .M unit (.M1, .M2) | 16 × 16 multiply operations |
| | 16 × 32 multiply operations |
| | Bit expansion |
| | Bit interleaving/de-interleaving |
| | Quad 8 × 8 multiply operations |
| | Paired 16 × 16 multiply operations |
| | Paired 16 × 16 multiply with |
| | add/subtract operations |
| | Quad 8 × 8 multiply with |
| | add operations |
| | Variable shift operations |
| | Rotation |
| | Galois Field Multiply |
| .D unit (.D1, .D2) | 32-bit add, subtract, linear and |
| | circular address calculation |
| | Loads and stores with 5-bit |
| | constant offset |
| | Loads and stores with 15-bit |
| | constant offset (.D2 only) |
| | Load and store double words with |
| | 5-bit constant |
| | Load and store non-aligned words |
| | and double words |
| | 5-bit constant generation |
| | 32-bit logical operations |

Most data lines in the CPU support 32-bit operands, and some support long (40-bit) and double word (64-bit) operands. Each functional unit has its own 32-bit write port into a general-purpose register file (Refer to FIG. 2). All units ending in 1 (for example, .L1) write to register file A 20a and all units ending in 2 write to register file B 20b. Each functional unit has two 32-bit read ports for source operands src1 and src2. Four units (.L1, .L2, .S1, and .S2) have an extra 8-bit-wide port for 40-bit long writes, as well as an 8-bit input for 40-bit long reads. Because each unit has its own 32-bit write port, when performing 32 bit operations all eight units can be used in parallel every cycle. Since each multiplier can return up to a 64-bit result, two write ports are provided from the multipliers to the register file.

Register File Cross Paths

Each functional unit reads directly from and writes directly to the register file within its own data path. That is, .L1 unit 18a, .S1 unit 16a, .D1 unit 12a, and .M1 unit 14a write to register file A and .L2 unit 18b, .S2 unit 16b, .D2 unit 12b, and .M2 unit 14b write to register file B. The register files are connected to the opposite-side register file's functional units via the 1X and 2X cross paths. These cross paths allow functional units from one data path to access a 32-bit operand from the opposite side's register file. The 1X cross path 210 allows data path A's functional units to read their source from register file B, via multiplexers 211, 212, 213, 214. Similarly, the 2X cross path allows data path B's functional units to read their source from register file A.

All eight of the functional units have access to the opposite side's register file via a cross path. The .M1, .M2, .S1, .S2, .D1, and .D2 units' src2 inputs are selectable between the cross path and the same side register file. In the case of the .L1 and .L2 units 18a, 18b, both src1 and src2 inputs are also selectable between the cross path and the same-side register file, for example by operation of multiplexers 211, 212 as shown in FIG. 2 in connection with .L1 unit 18a. In addition, as shown in Table 2, transfers to control register file 102 over bus 220 and from control register file 102 over bus 221, may also be made via .S2 unit 16b only.

Only two cross paths, 1X and 2X, exist in this embodiment of the architecture. Thus the limit is one source read from each data path's opposite register file per cycle, or a total of two cross-path source reads per cycle. Advantageously, multiple units on a side may read the same cross-path source simultaneously. Thus the cross path operand for one side may be used by any one, multiple or all the functional units on that side in an execute packet. In the C62x/C67x, only one functional unit per data path, per execute packet could get an operand from the opposite register file.

A delay clock cycle is introduced whenever an instruction attempts to read a register via a cross path that was updated in the previous cycle. This is known as a cross path stall. This stall is inserted automatically by the hardware, as suggested by delay block 250 in FIG. 2; no NOP instruction is needed. It should be noted that no stall is introduced if the register being read is the destination for data loaded by a LDx instruction.

Memory, Load and Store Paths

Processor 10 supports double word loads and stores. There are four 32-bit paths for loading data for memory to the register file. For side A, LD1a is the load path for the 32 LSBs; LD1b is the load path for the 32 MSBs. For side B, LD2a is the load path for the 32 LSBs; LD2b is the load path for the 32 MSBs. There are also four 32-bit paths, for storing register values to memory from each register file. ST1a is the write path for the 32 LSBs on side A; ST1b is the write path for the 32 MSBs for side A. For side B, ST2a is the write path for the 32 LSBs; ST2b is the write path for the 32 MSBs.

Some of the ports for long and double word operands are shared between functional units. This places a constraint on which long or double word operations can be scheduled on a datapath in the same execute packet.

Data Address Paths

Bus 40a has an address bus DA1 which is driven by mux 200a. This allows an address generated by either load/store unit D1 or D2 to provide a memory address for loads or stores for register file 20a. Data Bus LD1 loads data from an address in memory 22 specified by address bus DA1 to a register in load unit D1. Unit D1 may manipulate the data provided prior to storing it in register file 20a. Likewise, data bus ST1 stores data from register file 20a to memory 22. Load/store unit D1 performs the following operations: 32-bit add, subtract, linear and circular address calculations. Load/store unit D2 operates similarly to unit D1, with the assistance of mux 200b for selecting an address.

The DA1 and DA2 resources and their associated data paths are specified as T1 and T2 respectively. T1 consists of the DA1 address path and the LD1a, LD1b, ST1a and ST1b data paths. Similarly, T2 consists of the DA2 address path and the LD2a, LD2b, ST2 a and ST2b data paths. The T1 and T2 designations appear in functional unit fields for load and store instructions.

For example, the following load instruction uses the .D1 unit to generate the address but is using the LD2a path resource from DA2 to place the data in the B register file. The use of the DA2 resource is indicated with the T2 designation, for example: LDW .DT2 *A0[3], B1.

Table 3 defines the mapping between instructions and functional units for a set of basic instructions included in a DSP described in U.S. patent application Ser. No. 09/012,813, now U.S. Pat. No. 6,182,203 (incorporated herein by reference). Table 4 defines a mapping between instructions and functional units for a set of extended instructions in an embodiment of the present invention. Alternative embodiments of the present invention may have different sets of instructions and functional unit mapping. Table 3 and Table 4 are illustrative and are not exhaustive or intended to limit various embodiments of the present invention.

TABLE 3
Instruction to Functional Unit Mapping of Basic Instructions

| .L Unit | .M Unit | .S Unit | .D Unit |
|---|---|---|---|
| ABS | MPY | ADD | ADD |
| ADD | SMPY | ADDK | ADDA |
| AND | | ADD2 | LD mem |
| CMPEQ | | AND | LD mem (15-bit offset) (D2 only) |
| CMPGT | | B disp | MV |
| CMPGTU | | B IRP | NEG |
| CMPLT | | B NRP | ST mem |
| CMPLTU | | B reg | ST mem (15-bit offset) (D2 only) |
| LMBD | | CLR | SUB |
| MV | | EXT | SUBA |
| NEG | | EXTU | ZERO |
| NORM | | MVC | |
| NOT | | MV | |
| OR | | MVK | |
| SADD | | MVKH | |
| SAT | | NEG | |
| SSUB | | NOT | |
| SUB | | OR | |
| SUBC | | SET | |
| XOR | | SHL | |
| ZERO | | SHR | |
| | | SHRU | |
| | | SSHL | |
| | | STP (S2 only) | |
| | | SUB | |
| | | SUB2 | |
| | | XOR | |
| | | ZERO | |

The following are examples of what the syntax looks like for the ADD instruction:

1) ADD (.unit) src1, src2, dst

2) ADDU (.unit) src1, src2, dst

3) ADD (.unit) src2, src1, dst

unit=.L1, .L2, .S1, .S2, .D1, .D2

src and dst indicate source and destination respectively. The (.unit) dictates which functional unit the instruction is mapped to (.L1, .L2, .S1, .S2, .Ml, .M2, .D1, or .D2). This instruction has three opcode map fields: src1, src2, and dst.

The addressing modes for instructions that access memory may be linear or circular. The mode is specified by an addressing mode register (AMR) contained in control register file 102. Eight registers can perform circular addressing. A4-A7 are used by the .D1 unit and B4-B7 are used by the .D2 unit. No other units can perform circular addressing modes. For each of these registers, the AMR specifies the addressing mode.

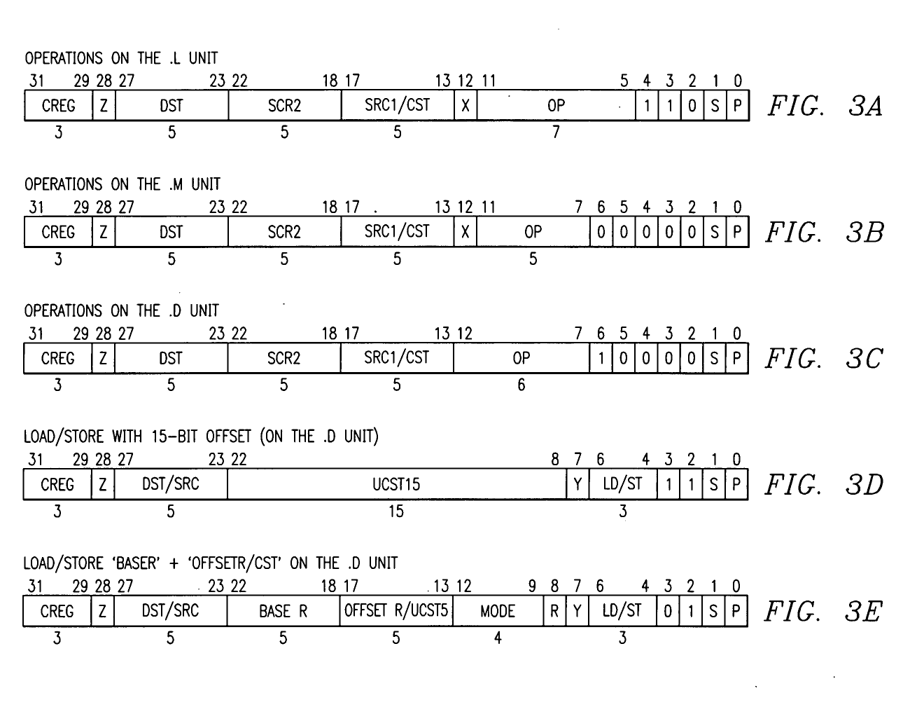

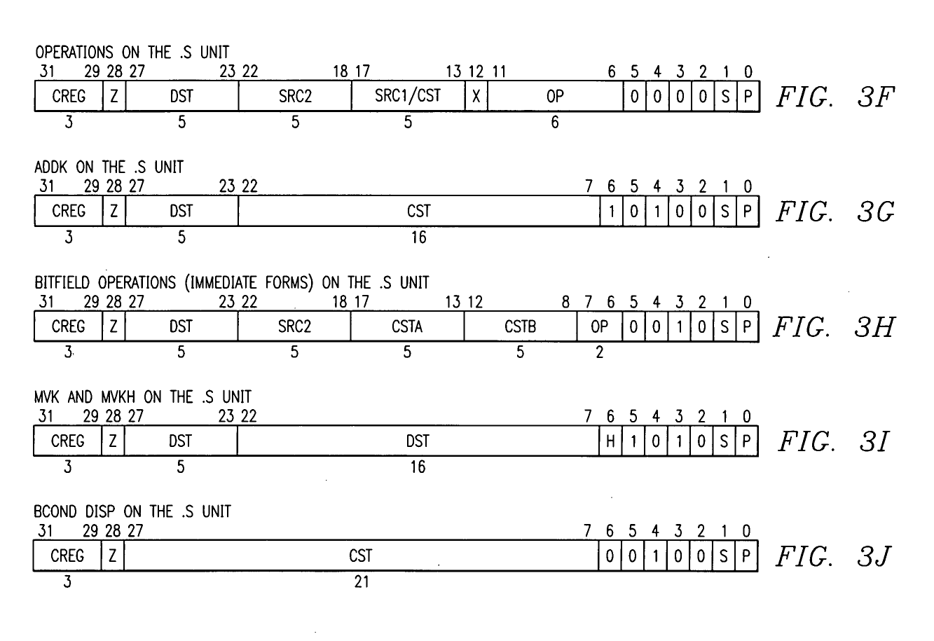

All instructions can be conditional. The condition is controlled by a 3-bit (creg) field specifying a register to be tested, and a 1-bit field (z) specifying a test for zero or nonzero, as shown in FIGS. 3A-3J. The four MSBs of every opcode are creg and z. The specified register is tested at the beginning of the E1 instruction execution pipeline stage for all instructions. The pipeline is described later herein. If z=1, the test is for equality with zero. If z=0, the test is for nonzero. The case of condition register field (creg)=0 and z=0 is treated as always true to allow instructions to be executed unconditionally. The creg register field is encoded as shown in Table 5. Conditional instructions are represented by “[ ]” surrounding the condition register.

TABLE 4
Instruction to Functional Unit Mapping of Extended Instructions

| .L unit | .M unit | .S unit | .D unit |
|---|---|---|---|
| ABS2 | AVG2 | ADD2 | ADD2 |
| ADD2 | AVGU4 | ADDKPC | AND |
| ADD4 | BITC4 | AND | ANDN |
| AND | BITR | ANDN | LDDW |
| ANDN | DEAL | BDEC | LDNDW |
| MAX2 | DOTP2 | BNOP | LDNW |
| MAXU4 | DOTPN2 | BPOS | MVK |
| MIN2 | DOTPNRSU2 | CMPEQ2 | OR |
| MINU4 | DOTPNRUS2 | CMPEQ4 | STDW |
| | DOTPRSU2 | CMPGT2 | |
| | DOTPRUS2 | CMPGTU4 | |
| MVK | DOTPSU4 | CMPLT2 | STNDW |
| | DOTPUS4 | | |
| OR | DOTPU4 | CMPLTU4 | STNW |
| PACK2 | GMPY4 | MVK | SUB2 |
| PACKH2 | MPY2 | OR | XOR |
| PACKH4 | MPYHI | PACK2 | |
| PACKHL2 | MPYHIR | PACKH2 | |
| | MPYIH | | |
| | MPYIHR | | |
| PACKL4 | MPYIL | PACKHL2 | |
| | MPYILR | | |
| | MPYLI | | |
| PACKLH2 | MPYLIR | PACKLH2 | |
| SHLMB | MPYSU4 | SADD2 | |
| | MPYUS4 | | |
| SHRMB | MPYU4 | SADDU4 | |
| SUB2 | MVD | SADDSU2 | |
| | | SADDUS2 | |
| SUB4 | ROTL | SHLMB | |
| SUBABS4 | SHFL | SHR2 | |
| SWAP2 | SMPY2 | SHRMB | |
| SWAP4 | SSHVL | SHRU2 | |
| UNPKHU4 | SSHVR | SPACK2 | |
| UNPKLU4 | XPND2 | SPACKU4 | |
| XOR | XPND4 | SUB2 | |
| | | SWAP2 | |
| | | UNPKHU4 | |
| | | UNPKLU4 | |
| | | XOR | |

The DSP's opcode map is shown in FIGS. 3A-3J. Refer to the instruction descriptions later herein for explanations of the field syntax and values. An instruction syntax is used to describe each instruction. The opcode map breaks down the various bit fields that make up each instruction. There are certain instructions that can be executed on more than one functional unit, as was shown in Table 4. The syntax specifies the functional unit and various resources used by an instruction, typically as follows:

### EXAMPLE (.unit) src, dst

TABLE 5
Registers That Can Be Tested by Conditional Operations

| | |
|---|---|
| Creg | z |

| 31 | 30 | 29 | 28 | Register Tested |
|---|---|---|---|---|
| 0 | 0 | 0 | 0 | Unconditional. |
| 0 | 0 | 0 | 1 | Reserved: When selected this indicates |
| | | | | a SWBP instruction |
| 0 | 0 | 1 | z | B0 |
| 0 | 1 | 0 | z | B1 |
| 0 | 1 | 1 | z | B2 |
| 1 | 0 | 0 | z | |
| 1 | 0 | 0 | z | A1 |
| 1 | 0 | 1 | z | A2 |
| 1 | 1 | x | x | Reserved |

Note:
x is don't care for reserved cases.

Instructions are always fetched eight at a time. This constitutes a fetch packet. The execution grouping of the fetch packet is specified by the p-bit, bit zero, of each instruction. Fetch packets are 8-word aligned.

The p bit controls the parallel execution of instructions. The p bits are scanned from left to right (lower to higher address). If the p bit of instruction i is 1, then instruction i+1 is to be executed in parallel with (in the same cycle as) instruction i. If the p-bit of instruction i is 0, then instruction i+1 is executed in the cycle after instruction i. All instructions executing in parallel constitute an execute packet. An execute packet can contain up to eight instructions. All instructions in an execute packet must use a unique functional unit.

Pipeline Operation

The DSP pipeline has several key features which improve performance, decrease cost, and simplify programming. They are: increased pipelining eliminates traditional architectural bottlenecks in program fetch, data access, and multiply operations; control of the pipeline is simplified by eliminating pipeline interlocks; the pipeline can dispatch eight parallel instructions every cycle; parallel instructions proceed simultaneously through the same pipeline phases; sequential instructions proceed with the same relative pipeline phase difference; and load and store addresses appear on the CPU boundary during the same pipeline phase, eliminating read-after-write memory conflicts.

A multi-stage memory pipeline is present for both data accesses and program fetches. This allows use of high-speed synchronous memories both on-chip and off-chip, and allows infinitely nestable zero-overhead looping with branches in parallel with other instructions.

There are no internal interlocks in the execution cycles of the pipeline, so a new execute packet enters execution every CPU cycle. Therefore, the number of CPU cycles for a particular algorithm with particular input data is fixed. If during program execution, there are no memory stalls, the number of CPU cycles equals the number of clock cycles for a program to execute.

Performance can be inhibited by stalls from the memory system, stalls for cross path dependencies, or interrupts. The reasons for memory stalls are determined by the memory architecture. Cross path stalls are described in detail in U.S. patent Ser. No. 09/702,453, filed Oct. 31, 2000, to Steiss, et al and is incorporated herein by reference. To fully understand how to optimize a program for speed, the sequence of program fetch, data store, and data load requests the program makes, and how they might stall the CPU should be understood.

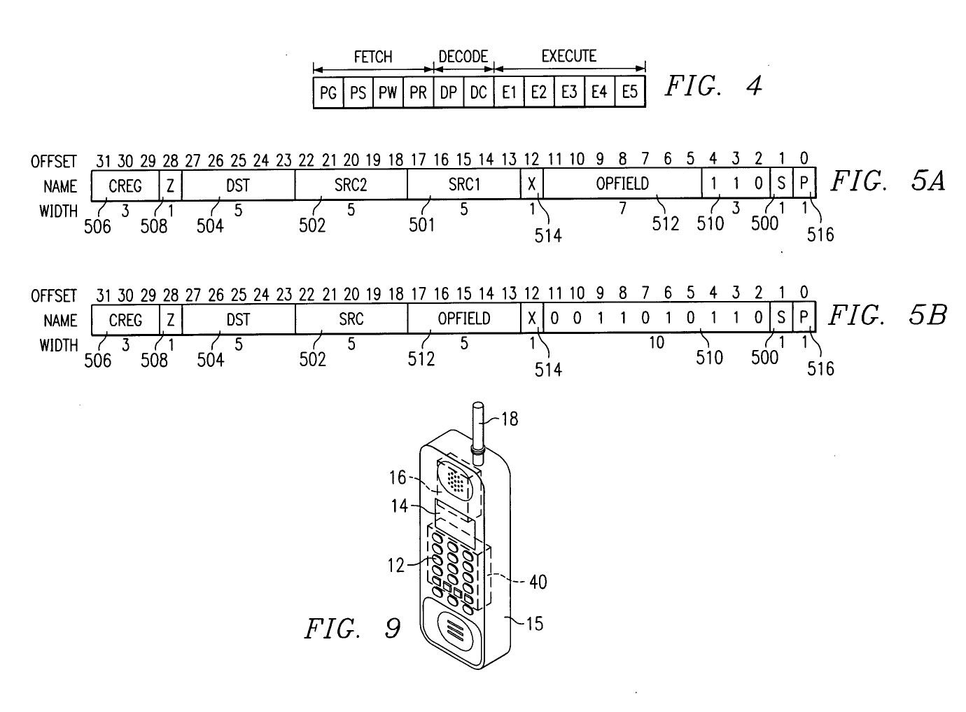

The pipeline operation, from a functional point of view, is based on CPU cycles. A CPU cycle is the period during which a particular execute packet is in a particular pipeline stage. CPU cycle boundaries always occur at clock cycle boundaries; however, stalls can cause CPU cycles to extend over multiple clock cycles. To understand the machine state at CPU cycle boundaries, one must be concerned only with the execution phases (E1-E5) of the pipeline. The phases of the pipeline are shown in FIG. 4 and described in Table 6.

TABLE 6
Pipeline Phase Description

| | | | | Instruction |
|---|---|---|---|---|
| | | | | Types |
| Pipeline | Pipeline Phase | Symbol | During This Phase | Completed |
| Program | Program Address | PG | Address of the fetch packet is determined. | |
| Fetch | Generate | | | |
| | Program Address | PS | Address of fetch packet is sent to memory. | |
| | Send | | | |
| | Program Wait | PW | Program memory access is performed. | |
| | Program Data | PR | Fetch packet is expected at CPU boundary. | |
| | Receive | | | |
| Program | Dispatch | DP | Next execute packet in fetch packet determined and | |
| Decode | | | sent to the appropriate functional units to be decoded. | |
| | Decode | DC | Instructions are decoded at functional units. | |
| Execute | Execute 1 | E1 | For all instruction types, conditions for instructions | Single- |
| | | | are evaluated and operands read. | cycle |
| | | | Load and store instructions: address generation is | |
| | | | computed and address modifications written to register | |
| | | | file^{†} | |
| | | | Branch instructions: affects branch fetch packet in PG | |
| | | | phase^{†} | |
| | | | Single-cycle instructions: results are written to a | |
| | | | register file^{†} | |
| | Execute 2 | E2 | Load instructions: address is sent to memory^{†} | Stores |
| | | | Store instructions and STP: address and data are sent | STP |
| | | | to memory^{†} | |
| | | | Single-cycle instructions that saturate results set the | Multiplies |
| | | | SAT bit in the Control Status Register (CSR) if | |
| | | | saturation occurs.^{†} | |
| | | | Multiply instructions: results are written to a register | |
| | | | file^{†} | |
| | Execute 3 | E3 | Data memory accesses are performed. Any multiply | |
| | | | instruction that saturates results sets the SAT bit in | |
| | | | the Control Status Register (CSR) if saturation occurs.^{†} | |
| | Execute 4 | E4 | Load instructions: data is brought to CPU boundary^{†} | |
| | Execute 5 | E5 | Load instructions: data is loaded into register^{†} | Loads |

^{†}This assumes that the conditions for the instructions are evaluated as true. If the condition is evaluated as false, the instruction will not write any results or have any pipeline operation after E1.

Referring again to FIG. 4 and FIG. 1, the instruction execution pipeline of processor 10 involves a number of discrete stages, generally demarcated by temporary latches or registers to pass the results of one stage to the next. Instruction pipeline phases PG, PS, PW, and PR all involve instruction fetching and are embodied in program fetch circuit 10 in association with program memory subsystem 23. Pipeline phases DP and DC involve instruction decoding; phase DP is embodied in dispatch circuitry 10b, while pipeline phase DC is embodied in decode circuitry 10c. The execution phases E1-E5 are embodied in stages embodied within each functional unit L, S, M and D. For example, the D units embody all five execute stage in association with memory subsystem 22. Other of the functional units do not embody all five execution phase, but only what is required for the instruction types that are executed by a particular functional unit.

The execution of instructions can be defined in terms of delay slots, as shown in Table 7. A delay slot is a CPU cycle that occurs after the first execution phase (E1) of an instruction in which results from the instruction are not available. For example, a multiply instruction has 1 delay slot, this means that there is 1 CPU cycle before another instruction can use the results from the multiply instruction.

TABLE 7
Delay Slot Summary

| | | Execute |
|---|---|---|
| Instruction Type | Delay Slots | Stages Used |
| Branch (The cycle when the | 5 | E1-branch |
| target enters E1) | | target E1 |
| Load (LD) (Incoming Data) | 4 | E1-E5 |
| Load (LD) (Address Modification) | 0 | E1 |
| Multiply | 1 | E1-E2 |
| Single-cycle | 0 | E1 |
| Store | 0 | E1 |
| NOP (no execution pipeline operation) | — | — |
| STP (no CPU internal results written) | — | — |

Single cycle instructions execute during the E1 phase of the pipeline. The operand is read, operation is performed and the results are written to a register all during E1. These instructions have no delay slots.

Multiply instructions complete their operations during the E2 phase of the pipeline. In the E1 phase, the operand is read and the multiply begins. In the E2 phase, the multiply finishes, and the result is written to the destination (dst) register. Multiply instructions have 1 delay slot.

Load instructions have two results: data loaded from memory and address pointer modification.

Data loads complete their operations during the E5 phase of the pipeline. In the E1 phase, the address of the data is computed. In the E2 phase, the data address is sent to data memory. In the E3 phase, a memory read is performed. In the E4 stage, the data is received at the CPU core boundary. Finally, in the E5 phase, the data is loaded into a register. Because data is not written to the register until E5, these instructions have 4 delay slots. Because pointer results are written to the register in E1, there are no delay slots associated with the address modification.

Store instructions complete their operations during the E3 phase of the pipeline. In the E1 phase, the address of the data is computed. In the E2 phase, the data address is sent to data memory. In the E3 phase, a memory write is performed. The address modification is performed in the E1 stage of the pipeline. Even though stores finish their execution in the E3 phase of the pipeline, they have no delay slots and follow the following rules (i=cycle):

1) When a load is executed before a store, the old value is loaded and the new value is stored.

2) When a store is executed before a load, the new value is stored and the new value is loaded.

3) When the instructions are in are in parallel, the old value is loaded and the new value is stored.

Byte Intermingling Instructions

The DSP of FIG. 1, which is an embodiment of the present invention, includes an extensive set of packed data instructions that provide features of single instruction, multiple data (SIMD) operation. These instructions operate directly on packed data to streamline data flow and increase instruction set efficiency. By so doing, performance of the processor is improved. They are summarized in Table 8 below:

TABLE 8
Instructions for Operating Directly on Packed Data

| | Quad | Paired |
|---|---|---|
| Operation | 8-bit | 16-bit |
| Multiply | X | X |
| Multiply with Saturation | | X |
| Addition/Subtraction | X | X* |
| Addition with Saturation | X | X |
| Absolute Value | | X |
| Subtract with Absolute Value | X | |
| Compare | X | X |
| Shift | | X |
| Data Pack/Unpack | X | X |
| Data Pack with Saturation | X | X |
| Dot product with optional negate | X | X |
| Min/Max/Average | X | X |
| Bit-expansion (Mask generation) | X | X |

In order to simplify manipulation of the packed data, a set of byte intermingling instructions is provided. This set of instructions is described in Table 9.

TABLE 9
Byte Intermingling Instruction Set Description

| | |
|---|---|
| PACK2 | Pack 16lsb, 16lsb into Packed 16-bit: The PACK2 |
| | instruction takes the lower half-words from src1 and |
| | src2 and packs them both into dst. The lower half-word |
| | of src1 is placed in the upper half-word of dst. The |
| | lower half-word of src2 is placed in the lower |
| | half-word of dst. This instruction is useful for |
| | manipulating and preparing pairs of 16-bit values |
| | to be used by the packed arithmetic operations, |
| | such as ADD2. |
| PACKH2 | Pack 16msb, 16msb into Packed 16-bit: The PACKH2 |
| | instruction takes the upper half-words from src1 |
| | and src2 and packs them both into dst. The upper |
| | half-word of src1 is placed in the upper half-word |
| | of dst. The upper half-word of src2 is placed |
| | in the lower half-word of dst. This instruction is |
| | useful for manipulating and preparing pairs of 16-bit |
| | values to be used by the packed arithmetic |
| | operations, such as ADD2. |
| PACKH4 | Pack High Bytes of Four Half-words into Packed |
| | 8-bit: The PACKH4 instruction moves the high bytes |
| | of the two half-words in src1 and src2 and packs |
| | them into dst. The bytes from src1 will be packed |
| | into the most significant bytes of dst, and the |
| | bytes from src2 will be packed into the least |
| | significant bytes of dst. |
| | Specifically, the high byte of the upper half-word |
| | of src1 is moved to the upper byte of the upper |
| | half-word of dst. The high byte of the lower half-word |
| | of src1 is moved to the lower byte of the upper |
| | half-word of dst. The high byte of the upper |
| | half-word of src2 is moved to the upper byte of the |
| | lower half-word of dst. The high byte of the lower |
| | half-word of src2 is moved to the lower byte of the |
| | lower half-word of dst. |
| PACKHL2 | Pack 16msb, 16lsb into Packed 16-bit: The |
| | PACKHL2 instruction takes the upper half-word |
| | from src1 and the lower half-word from src2 and |
| | packs them both into dst. The upper half-word of |
| | src1 is placed in the upper half-word of dst. The |
| | lower half-word of src2 is placed in the lower |
| | half-word of dst. |
| | This instruction is useful for manipulating and |
| | preparing pairs of 16-bit values to be used by the |
| | packed arithmetic operations, such as ADD2. |
| PACKL4 | Pack Low Bytes of Four Half-words into Packed |
| | 8-bit: The PACKL4 instruction moves the low bytes |
| | of the two half-words in src1 and src2 and packs |
| | them into dst. The bytes from src1 will be |
| | packed into the most significant bytes of dst, |
| | and the bytes from src2 will be packed into the |
| | least significant bytes of dst. |
| | Specifically, the low byte of the upper half-word |
| | of src1 is moved to the upper byte of the upper |
| | half-word of dst. The low byte of the lower |
| | half-word of src1 is moved to the lower byte |
| | of the upper half-word of dst. The low byte of |
| | the upper half-word of src2 is moved to the upper |
| | byte of the lower half-word of dst. The low byte of |
| | the lower half-word of src2 is moved to the lower |
| | byte of the lower half-word of dst. |
| PACKLH2 | Pack 16lsb, 16msb into Packed 16-bit: The |
| | PACKLH2 instruction takes the lower half-word |
| | from src1 and the upper half-word from src2 and |
| | packs them both into dst. The lower half-word of |
| | src1 is placed in the upper half-word of dst. |
| | The upper half-word of src2 is placed in the |
| | lower half-word of dst. |
| | This instruction is useful for manipulating and |
| | preparing pairs of 16-bit values to be used by the |
| | packed arithmetic operations, such as ADD2. |
| SHLMB | Shift Left and Merge Byte: The SHLMB instruction |
| | shifts the contents of src2 left by one byte, and |
| | then the most significant byte of src1 is merged |
| | into the least significant byte position. |
| | The result is then placed in dst. |
| SHRMB | Shift Right and Merge Byte: The SHRMB instruction |
| | shifts the contents of src2 right by one byte, |
| | and then the least significant byte of src1 is |
| | merged into the most significant byte position. |
| | The result is then placed in dst. |
| SWAP2 | Swap Half-words in Each Word (Pseudo-Operation): |
| | The SWAP2 is a pseudo-operation that takes the |
| | lower half-word from src2 and places it in the |
| | upper half-word of dst while the upper-half word |
| | from src2 is placed in the lower half-word of dst. |
| | It assembles as PACKLH2 src, src, dst. |
| | This instruction is useful for manipulating and |
| | reparing pairs of 16-bit values to be used by |
| | the packed arithmetic operations, such as ADD2. |
| | The SWAP2 instruction can be used in conjunction |
| | with the SWAP4 instruction to change the byte |
| | ordering (and therefore, the endianness) of |
| | 32-bit data. |
| SWAP4 | Swap Bytes in Each Half-word: The SWAP4 |
| | instruction exchanges pairs of bytes within each |
| | half-word of src2, placing the result in dst. |
| | The values in src2 are treated as packed 8-bit |
| | values. |
| | Specifically, the upper byte in the upper |
| | half-word is placed in the lower byte in the upper |
| | halfword while the lower byte of the upper half-word |
| | is placed in the upper byte of the upper half-word. |
| | Also the upper byte in the lower half-word is placed |
| | in the lower byte of the lower half-word while the |
| | lower byte in the lower half-word is placed in the |
| | upper byte of the lower half word. |
| | By itself, this instruction changes the ordering |
| | of bytes within half words. This effectively changes |
| | the endianness of 16-bit data packed in 32-bit words. |
| | The endianness of full 32-bit |
| | quantities can be changed by using the SWAP4 |
| | instruction in conjunction with the SWAP2 instruction |
| UNPKHU4 | Unpack High Unsigned Packed 8-bit to Unsigned |
| | Packed 16-bit: The UNPKHU4 instruction moves the |
| | two most significant bytes of src2 into the two |
| | low bytes of the two half-words of dst. |
| | Specifically, the upper byte in the upper half-word |
| | is placed in the lower byte in the upper halfword |
| | while the lower byte of the upper half-word is |
| | placed in the lower byte of the lower |
| | half-word. The src2 bytes are zero-extended when |
| | unpacked, filling the two high bytes of the two |
| | half-words of dst with zeros. |
| UNPKLU4 | Unpack Low Unsigned Packed 8-bit to Unsigned |
| | Packed 16-bit: The UNPKLU4 instruction moves the |
| | two least significant bytes of src2 into the two |
| | low bytes of the two half-words of dst. Specifically, |
| | the upper byte in the lower half-word is placed |
| | in the lower byte in the upper halfword while the |
| | lower byte of the lower half-word is kept in the |
| | lower byte of the lower half-word. The src2 bytes |
| | are zero-extended when unpacked, filling the two |
| | high bytes of the two half-words of dst with zeros. |

FIG. 5A illustrates an instruction syntax for byte intermingling instructions that selects byte fields from both a first source operand and from a second source operand, such as the Shift Left, Merge Byte (SHLMB) instruction. FIG. 5B illustrates an instruction syntax for a byte intermingling instructions that selects byte fields from only one source operand, as the SWAP4 instruction. In this embodiment, all of the byte intermingling instructions can be executed in either .L functional unit 18a or 18b as indicated by unit select bit field 500. The instruction includes a first source operand field (src1) 501 and a second source operand field (src2) 502 that each select a register from associated register file 20a or 20b to access a source operand which is a 32-bit data value. The byte intermingling instructions each perform a byte intermingling operation on various fields selected from the source operands. The values in the source operands are treated as packed data, and the result is written in a corresponding packed format in a destination register specified by a destination field (dst) 504. Each of the byte intermingling instructions in this embodiment, except SWAP4, PACKH4 and PACKL4, can also be executed on either .S unit in response to a different value in type field 510 and opcode field 512.

Referring still to FIG. 5, field 510 defines a class of instruction formats, while opcode field 512 specifies that a particular instruction of this class is one of the byte intermingling instruction listed in Table 25. Crossover control field 514 specifies which register file 20a or 20b will be accessed for a source operand, as discussed previously. Parallel bit 516 indicates if this instruction is to be executed in parallel with an adjacent instruction in a fetch packet, as discussed previously.

As with all of the instructions executed by the DSP of FIG. 1, the byte intermingling instructions are conditional based on a predicate register selected by condition register field (creg) 506 and zero indicator bit 508, as discussed previously. Table 10 defines the operation of the SHLMB instruction using pseudo code. Just as with other conditionally executed instructions, if the predicate condition tests false, SHLMB does not complete execution and the write of the dst register is inhibited. The other byte intermingling instructions listed in Table 9 have a similar pseudo code, except that different bytes are selected from the first source operand (src1) and the second source operand (src2) and the selected bytes are placed in different orders in the destination operand (dst).

TABLE 10
Execution of SHLMB Instruction

if (cond) {
ubyte2(src2) → ubyte3(dst);
ubyte1(src2) → ubyte2(dst);
ubyte0(src2) → ubyte1(dst);
ubyte3(src1) → ubyte0(dst);

}

else nop

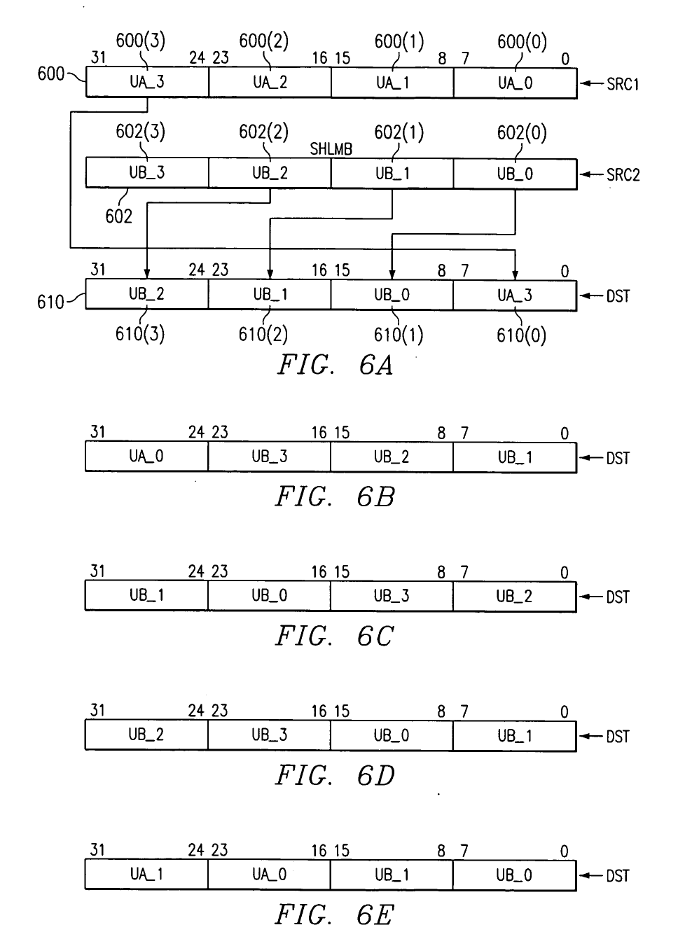

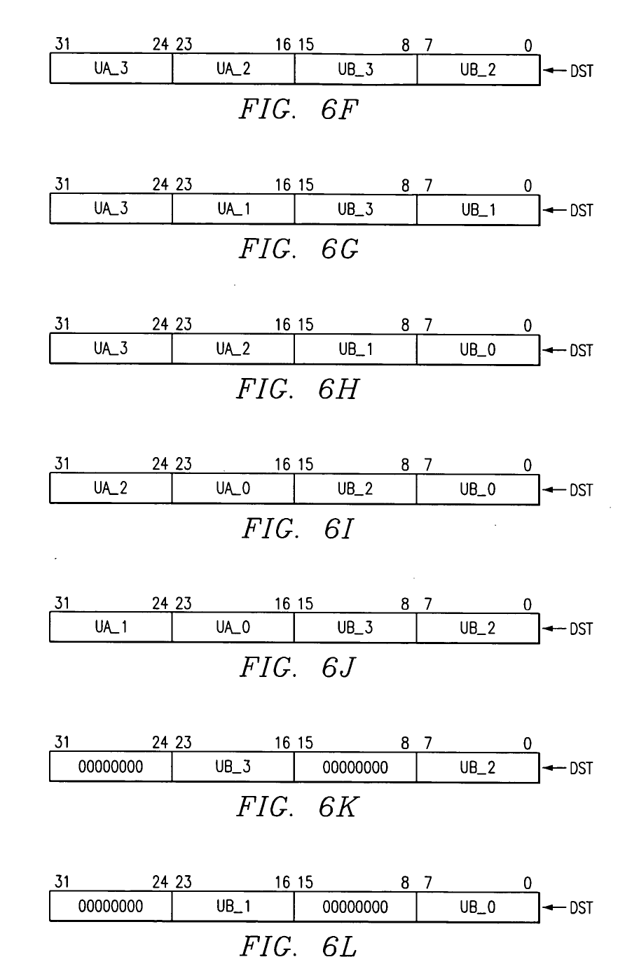

FIG. 6A is a flow chart illustrating operation of a Shift Left and Merge Byte (SHLMB) instruction. The SHLMB instruction shifts the contents of src2 left by one byte, and then the most significant byte of src1 is merged into the least significant byte position. The result is then placed in dst. A data value in a first selected source operand 600 is treated as packed, unsigned 8-bit data, located in four distinct fields 600(0-3). A data value in a second selected source operand 602 is also treated as packed unsigned 8-bit data, located in four distinct fields 602(0-3). Three fields 602(2-0) are selected from a least significant portion of the second source operand 602 and shifted left and placed in order in fields 610(3-1) of destination operand 610. A most significant field 600(3) is selected from the first source operand 600 and placed in a least significant position 610(0) in destination operand 610. Thus, a destination operand is formed that has unsigned bytes selected from the first operand (ua_n) and from the second operand (ub_n) in the following order: ub_2, ub_1, ub_0, and ua_3. In this embodiment, the destination is written during pipeline phase E1 and the SHLMB instruction is categorized has having no delay slots.

Each of the other byte intermingling instructions described in Table 9 operates in a similar manner to select fields from a selected pair of source operands and intermingle the selected fields in an order in accordance with each one of the set of byte intermingling instructions.

FIG. 6B illustrates a destination operand for a Shift Right and Merge Byte (SHRMB) instruction. Thus, a destination operand is formed that has unsigned bytes selected from the two source operands in the following order: ua_0, ub_3, ub_2, and ub_1.

FIG. 6C illustrates a destination operand for a Swap half word (SWAP2) instruction. Thus, a destination operand is formed that has unsigned bytes selected from just the second source operand in the following order: ub_1, ub_0, ub_3, and ub_2.

FIG. 6D illustrates a destination operand for a Swap Bytes in each half word (SWAP4) instruction. Thus, a destination operand is formed that has unsigned bytes selected from just the second source operand in the following order: ub_2, ub_3, ub_0, and ub_1.

FIG. 6E illustrates a destination operand for a Pack two low half words (PACK2) instruction. Thus, a destination operand is formed that has unsigned bytes selected from the two source operands in the following order: ua_1, ua_0, ub_1, and ub_0.

FIG. 6F illustrates a destination operand for a Pack two High half words (PACKH2) instruction. Thus, a destination operand is formed that has unsigned bytes selected from the two source operands in the following order: ua_3, ua_2, ub_3, and ub_2.

FIG. 6G illustrates a destination operand for a Pack High bytes of four half words (PACKH4) instruction. Thus, a destination operand is formed that has unsigned bytes selected from the two source operands in the following order: ua_3, ua_1, ub_3, and ub_1.

FIG. 6H illustrates a destination operand for a Pack High half word and Low half word (PACKHL2) instruction. Thus, a destination operand is formed that has unsigned bytes selected from the two source operands in the following order: ua_3, ua_2, ub_1, and ub_0.

FIG. 6I illustrates a destination operand for a Pack Low bytes of Four half words (PACKL4) instruction. Thus, a destination operand is formed that has unsigned bytes selected from the two source operands in the following order: ua_2, ua_0, ub_2, and ub_0.

FIG. 6J illustrates a destination operand for a Pack Low half word and High half words (PACKLH2) instruction. Thus, a destination operand is formed that has unsigned bytes selected from the two source operands in the following order: ua_1 ua_0, ub_3, and ub_2.

FIG. 6K illustrates a destination operand for an Unpack High Unsigned 8-bit to unsigned 16-bit (UNPKHU4) instruction. Thus, a destination operand is formed that has unsigned bytes selected from just the second source operand in the following order: 00000000h, ub_3, 00000000h, and ub_2.

FIG. 6L illustrates a destination operand for an Unpack Low Unsigned 8-bit to unsigned 16-bit (UNPKLU4) instruction. Thus, a destination operand is formed that has unsigned bytes selected from just the second source operand in the following order: 00000000h, ub_1, 00000000h, and ub_0.

Table 11 summarizes the byte ordering of the various destination operands formed by the set of byte intermingling instructions of this embodiment of the present invention.

TABLE 11
Summary of Destination Ordering for the
Set of Byte Intermingling Instructions

| | | | | |
|---|---|---|---|---|
| SHLMB | ub_2 | ub_1 | ub_0 | ua_3 |
| SHRMB | ua_0 | ub_3 | ub_2 | ub_1 |
| SWAP2 | ub_1 | ub_0 | ub_3 | ub_2. |
| SWAP4 | ub_2 | ub_3 | ub_0 | ub_1 |
| PACK2 | ua_1 | ua_0 | ub_1 | ub_0 |
| PACKH2 | ua_3 | ua_2 | ub_3 | ub_2 |
| PACKH4 | ua_3 | ua_1 | ub_3 | ub_1 |
| PACKHL2 | ua_3 | ua_2 | ub_1 | ub_0 |
| PACKL4 | ua_2 | ua_0 | ub_2 | ub_0 |
| PACKLH2 | ua_1 | ua_0 | ub_3 | ub_2 |
| UNPKHU4 | 00000000h | ub_3 | 00000000h | ub_2. |
| UNPKLU4 | 00000000h | ub_1 | 00000000h | ub_0 |

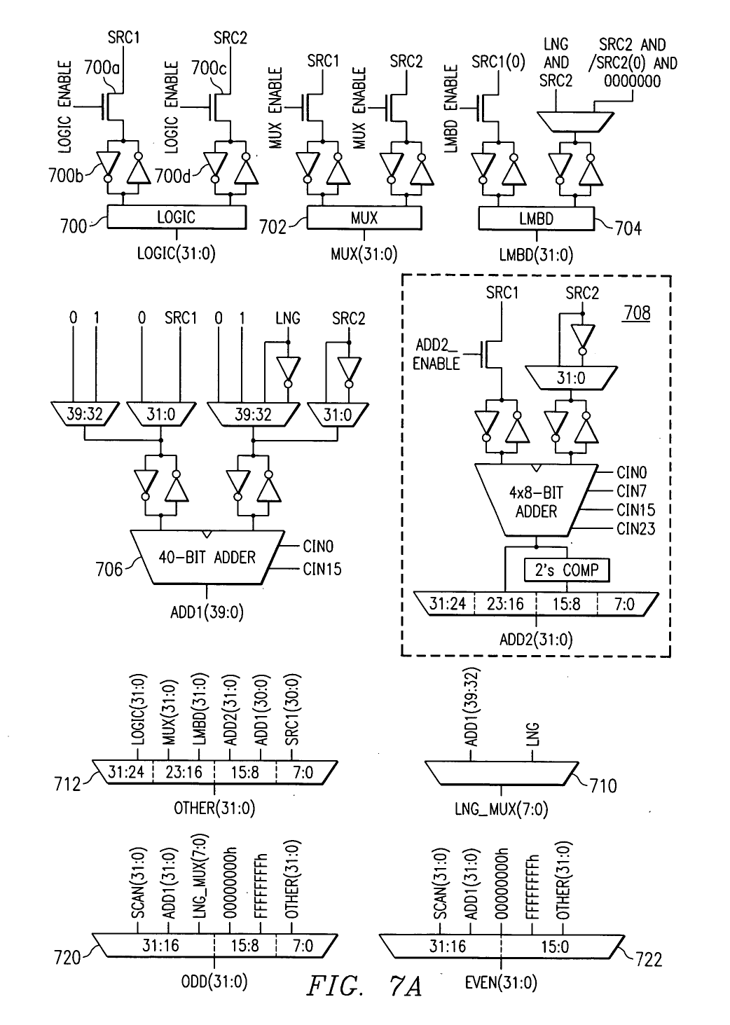

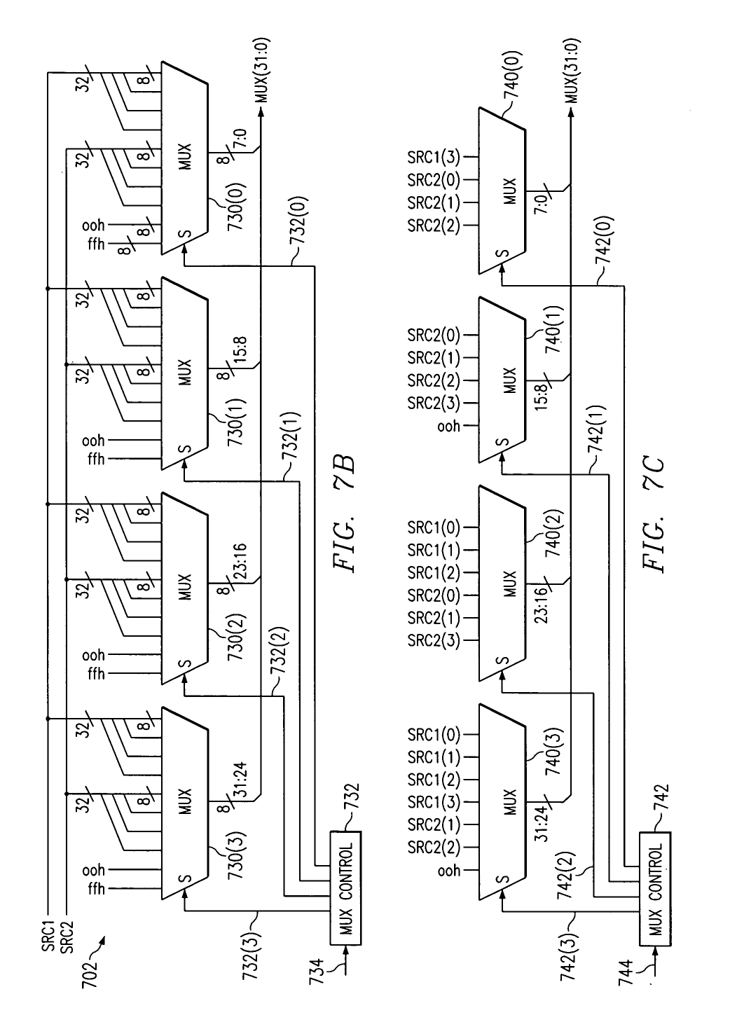

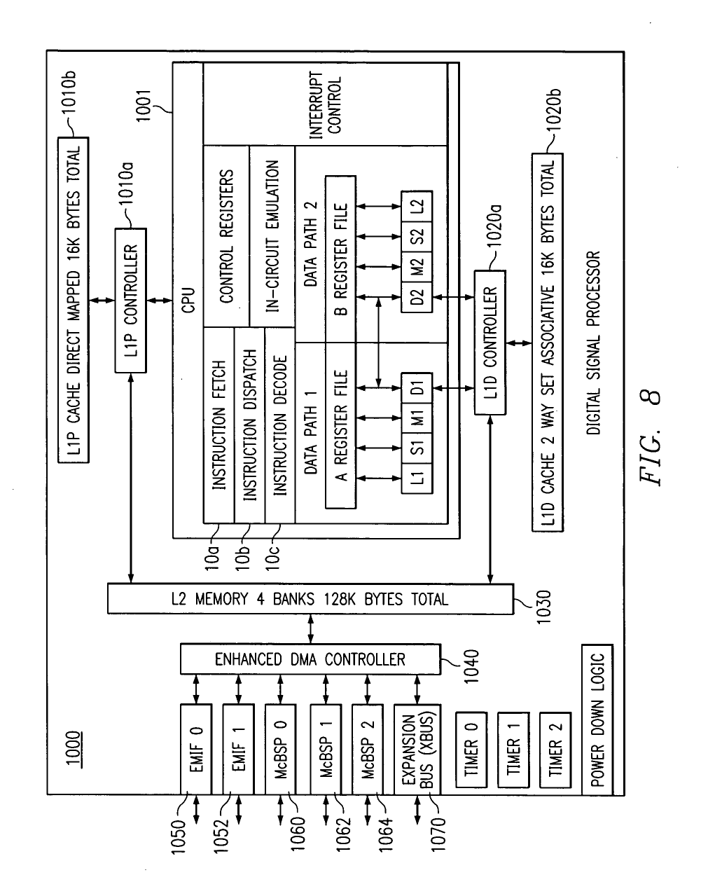

FIG. 7A is a top level block diagram of .L unit 18a or 18b, which is optimized to handle logical operations, although hardware is available for a set of add and subtract operations and also for the multi-field intermingling instruction of the present invention. Logic block 700 performs various Boolean logic functions. Pass gates 700a together with keeper gates 700b form a latch to hold the contents of a first source operand src1, which is selected from either register file 20a or 20b via mux 211 (see FIG. 2). Similarly, pass gates 700c together with keeper gates 700d form a latch to hold the contents of a second source operand src2, which is selected from either register file 20a or 20b via mux 212 (see FIG. 2).

Multiplexer block 702 provides byte intermingling and will be described in more detail with reference to FIG. 7B. Pass gates and keeper gates hold first and second source operands src1 and src2.

Left Most Bit Detection (LMBD) block 704 performs leftmost bit detection in src2 or long_src and src2 as specified by src1. First Adder block 706 performs 40-bit arithmetic using long_src and src2 and sign extended src1. Second Adder block 708 performs multi-field arithmetic on packed data fields in src1 and src2.

Long mux 710 selects from either the long_src LNG or the eight msbs ADD1(39:32) output from 40-bit adder 706 to odd-destination mux 720. Other mux 712 selects from the outputs of logic block 700, mux block 702, LMBD block 704, first adder block 706, second adder block 708 and src1. Other mux 712 is divided into four 8-bit sub-blocks that can each be controlled to select respective portions of the six sets of inputs.

Odd destination mux 720 selects from the outputs of a scan register SCAN31:0 (not shown), the first adder 706 bits ADD1(31:0), long mux 710, other mux 712 and zeros or ones. Odd mux 720 is divided into three separately controlled sections for bits 31:16, 15:8 and 7:0. Even destination register 722 selects from the outputs of a scan register SCAN31:0 (not shown), the first adder 706 bits ADD1(31:0), other mux 712 and zeros or ones. Even mux 722 is divided into two separately controlled sections for bits 31:16 and 15:0.

FIG. 7B is a more detailed block diagram of intermingling circuit 702 of FIG. 7A. Four separately controlled 8-bit multiplexers 730(3:0) are each connected to receive all thirty two bits of source operands src1 and src2, along with logical zeros and logical ones. Thus, any combination of byte fields can be selected from the two source operands and intermingled in any order to form a destination operand on output signal lines mux(31:0). Mux control circuitry 732 receives signals 734 from instruction decoding circuitry 10c (see FIG. 1) that indicate which byte intermingling instruction is being executed. Separate sets of control signals 732(3:0) are sent to each multiplexer to select to appropriate byte fields from src1 and src2 in response to the byte intermingling instruction that is being executed in order to form a destination operand.

FIG. 7C is an alternate embodiment of an intermingling circuit. Four separately controlled 8-bit multiplexers 740(3:0) are each connected to receive only the byte fields of source operands src1 and src2, along with logical zeros, needed to form the intermingled destination operands as indicated in Table 11. Thus, sets of byte fields can be selected from the two source operands and intermingled to form a destination operand on output signal lines mux(31:0) according to the set of byte intermingling instructions described in Table 9. Mux control circuitry 742 receives signals 744 from instruction decoding circuitry 10c (see FIG. 1) that indicate which byte intermingling instruction is being executed. Separate sets of control signals 742(3:0) are sent to each multiplexer to select to appropriate byte fields from src1 and src2 in response to the byte intermingling instruction that is being executed in order to form a destination operand.

Thus, the intermingling circuit forms a intermingled destination operand corresponding to a selected number of fields from a selected pair of source operands that are then written into respective field positions of a selected destination register during instruction pipeline E1 in response to a single byte intermingling instruction.

One skilled in the art will recognize that intermingling circuitry 702 may be implemented in a number of different ways, by using various configurations of multiplexers, shifters, barrel shifters, and such. In another embodiment, the intermingling circuitry may be implemented such that a multi-field byte intermingling instruction executes with a different number of delay slots, such as one or two, for example. In another embodiment, a bit field having a different width may be intermingled, such as four for example. There may be other varieties of intermingling instructions wherein different opcodes or a parameter is used to identify various bit field widths. In this embodiment of the present invention, intermingling circuitry is included in the L and S units of the CPU. However, in another embodiment, intermingling circuitry may be included in other or different functional units.

In another embodiment of the invention, an intermingled destination operand may be written directly to memory rather to a register file. This is described in more detail in Co-assigned U.S. patent application Ser. No. 09/687,540 entitled Data Processing System with Register Store/Load Utilizing Data Packing/Unpacking and is incorporated herein by reference.

FIG. 8 is a block diagram of an alternative embodiment of the present invention in a digital system 1000 including integrated circuit 1001 with a processor core corresponding to that described above relative to FIG. 1. A direct mapped program cache 1010b, having 16 kbytes capacity, is controlled by L1 Program (L1P) controller 1010a and connected thereby to the instruction fetch stage 10a. A 2-way set associative data cache 1020b, having a 16 Kbyte capacity, is controlled by L1 Data (L1D) controller 1020a and connected thereby to data units D1 and D2. An L2 memory 1030 having four banks of memory, 128 Kbytes total, is connected to L1P 1010a and to L1D 1020a to provide storage for data and programs. External memory interface (EMIF) 1050 provides a 64 bit data path to external memory, not shown, which provides memory data to L2 memory 1030 via extended direct memory access (DMA) controller 1040.

EMIF 1052 provides a 16-bit interface for access to external peripherals, not shown. Expansion bus 1070 provides host and I/O support similarly to host port 60/80 of FIG. 1.

Three multi-channel buffered serial ports (McBSP) 1060, 1062, 1064 are connected to DMA controller 1040. A detailed description of a McBSP is provided in U.S. patent Ser. No. 09/055,011, now U.S. Pat. No. 6,167,466 and is incorporated herein by reference.

FIG. 9 illustrates an exemplary implementation of a digital system that includes DSP 1 packaged in an integrated circuit 40 in a mobile telecommunications device, such as a wireless telephone 15. Wireless telephone 15 has integrated keyboard 12 and display 14. As shown in FIG. 9, DSP 1 is connected to the keyboard 12, where appropriate via a keyboard adapter (not shown), to the display 14, where appropriate via a display adapter (not shown) and to radio frequency (RF) circuitry 16. The RF circuitry 16 is connected to an aerial 18. Advantageously, by providing a set of multi-field byte intermingling instructions complex signal processing algorithms can be written in a more efficient manner to satisfy the demand for enhanced wireless telephony functionality.

Fabrication of digital system 10 involves multiple steps of implanting various amounts of impurities into a semiconductor substrate and diffusing the impurities to selected depths within the substrate to form transistor devices. Masks are formed to control the placement of the impurities. Multiple layers of conductive material and insulative material are deposited and etched to interconnect the various devices. These steps are performed in a clean room environment.

A significant portion of the cost of producing the data processing device involves testing. While in wafer form, individual devices are biased to an operational state and probe tested for basic operational functionality. The wafer is then separated into individual dice which may be sold as bare die or packaged. After packaging, finished parts are biased into an operational state and tested for operational functionality.

Thus, a digital system is provided with a processor having an improved instruction set architecture. The processor is code-compatible with C62xx DSP processors from Texas Instruments Incorporated. It provides a superset of the C62x architecture while providing complete code compatibility for existing C62x code. The processor provides extensions to the existing C62x architecture in several areas: register file enhancements, data path extensions, additional functional unit hardware, increased orthogonality of the instruction set, data flow enhancements, 8-bit and 16-bit extensions, and additional instructions that reduce code size and increase register flexibility.

Advantageously, a set of multi-field byte intermingling instructions is provided that provides features of single instruction, multiple data (SIMD) operation. Code size is thereby reduced and performance improved.

As used herein, the terms “applied,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

While the invention has been described with reference to illustrative embodiments, this description is not intended to be construed in a limiting sense. Various other embodiments of the invention will be apparent to persons skilled in the art upon reference to this description. In another embodiment, the source operands may be provided in response to a memory fetch instead of being read from the register file. An intermingling instruction may be executed in another functional unit instead of or in addition to the .L or .S functional units. In another embodiment, a different number of fields, such as eight, for example, could be intermingled. Different opcodes could define the number of fields, or a parameter could define the number of fields, for example.

In another embodiment, fewer byte intermingling instructions may be provided. Conversely, additional selections of byte intermingling may be provided.

In another embodiment, a control register is provided that is loaded with a control word to control the operation of a set of multiplexors and thereby provide a set of multi-field byte intermingling operations that provides features of single instruction, multiple data (SIMD) operation. For example, four bits are allocated in the control register for each byte of the destination. Using the four bits, any byte from any position of the source operands with up to sixteen options can be selected. Therefore, an eight byte destination can be completely specified using a 32-bit control register such that each byte of the destination can receive any byte from eight byte of a source operand, and additionally specify sign-extension, fill with zeros, fill with ones, and leave an original destination byte unaltered to form a merge, for example.

In another embodiment, the various fields overlap each other, such that the result for each field includes bits included within another field.

In another embodiment, values in each field could be treated as something other than an unsigned value, such as a signed value, or a floating point value, for example.

It is therefore contemplated that the appended claims will cover any such modifications of the embodiments as fall within the true scope and spirit of the invention.

1. A digital system comprising a microprocessor having an instruction execution pipeline with a plurality of pipeline phases, wherein the microprocessor comprises:
program fetch circuitry operable to perform a first portion of the plurality of pipeline phases;
instruction decode circuitry connected to receive fetched instructions from the program fetch circuitry, the instruction decode circuitry operable to perform a second portion of the plurality of pipeline phases; and
at least a first functional unit connected to receive control signals from the instruction decode circuitry, the functional unit operable to perform a third portion of the plurality of pipeline phases, the third portion being execution phases, wherein the first functional unit comprises:
byte intermingling circuitry connected to receive a single source operand having an ordered plurality of fields and having outputs connected to provide a destination operand in response to the control signals, wherein the byte intermingling circuitry is operable, responsive to one of a plurality of byte intermingling instructions, to place data from a first selected field of the single source operand in a lower field of a most significant portion of the destination operand, filling the remainder of the most significant portion of the destination operand with zeroes, and to place data from a second selected field of the single source operand, the second selected field being contiguous with and less significant than the first selected field, in a lower field of a least significant portion of the destination operand, filling the remainder of the least significant portion of the destination operand with zeroes.

2. The digital system of claim 1, wherein the byte intermingling circuitry is operable to receive the single source operand and to provide the destination operand during a single pipeline execution phase.

3. The digital system of claim 1, further comprising a register file connected to the first functional unit for providing the single source operand and connected to the first functional unit to receive the destination operand.

4. The digital system of claim 1, wherein each of the set of byte intermingling instructions has a field for identifying a predicate register.

5. The digital system of claim 1 being a cellular telephone, further comprising:
an integrated keyboard connected to the microprocessor via a keyboard adapter;
a display, connected to the microprocessor via a display adapter;
radio frequency (RF) circuitry connected to the microprocessor; and
an aerial connected to the RF circuitry.

6. A method of operating a digital system having a microprocessor and a set of byte intermingling instructions, comprising the steps of:
fetching a byte intermingling instruction for execution;
fetching a single source operand selected by the byte intermingling instruction, the single source operand comprising an ordered plurality of fields; and
writing, into a lower field of a most significant portion of a destination operand, data from a first selected field of the single source operand and filling the remainder of the most significant portion of the destination operand with zeroes, and writing, into a lower field of a least significant portion of the destination operand, data from a second selected field of the single source operand, the second selected field being contiguous with and less significant than the first selected field, and filling the remainder of the least significant portion of the destination operand with zeroes, the data being selected in accordance with the byte intermingling instruction.

7. The method of claim 6, wherein the step of writing is performed during a single execution phase of the microprocessor.

8. The method of claim 6, wherein the first selected field is a most significant byte of the single source operand, and wherein the second selected field is a next most significant byte of the single source operand.

9. The method of claim 6, wherein the second selected field is a least significant byte of the single source operand, and wherein the first selected field is a second least significant byte of the single source operand.
